(19) United States
(12) Patent Application Publication
(10) Pub. No.: US 2006/0168761 A1
(43) Pub. Date: Aug. 3, 2006

(54) Locking handle device

(76) Inventors: Joseph W. Christensen, Cedar Hills, UT (US); Jason Tippetts, Hillsboro, OR (US); Michael J. Pratt, Draper, UT (US)

Correspondence Address: KIRTON AND MCCONKIE;1800 EAGLE GATE TOWER, 60 EAST SOUTH TEMPLE, P O BOX 45120, SALT LAKE CITY, UT, 84145-0120, US

(21) Appl. No.: 11/265,927

(22) Filed: Nov. 3, 2005

Related U.S. Application Data
(60) Provisional application No. 60/624,934, filed on Nov. 4, 2004.

(51) Int. Cl. H01M 2/10

(52) U.S. Cl. 16/444

(57) ABSTRACT

A locking handle device capable of securely engaging complementary handle components and preventing their disengagement except upon deliberate actuation of a release element. A release element may be integral with the base portions of the handle such that application of an inward force to opposing release elements may transfer a substantially vertical and transverse force to the locked handles, thereby effectively disengaging complementary handle components.

### 1. RELATED APPLICATIONS

This application claims priority to U.S. Provisional Patent Application Ser. No. 60/624,934, filed Nov. 4, 2004.

### BACKGROUND

2. FIELD OF THE INVENTION

This invention relates to a handle assembly for a carrying case and more particularly to a handle device capable of selective securement requiring deliberate release.

### 3. BACKGROUND

Portable articles for transporting a load are well known in the art and range from simplistic devices such as grocery sacks, to sophisticated briefcases and designer luggage. Regardless of their specific utility, portable articles usually include handles or straps to facilitate load leverage and transport.

A duffel bag, for example, generally includes a primary opening that may be zipped closed, and two flaccid handles residing on opposite sides of the opening to facilitate closure, as well as to provide a clutch for the user. While capable of effective use, such handles are often difficult to maneuver and may be uncomfortable. Indeed, the handles have discrete edges, seams, and grips that may separately dig into and irritate a user's hand. In addition, since the handles are independent and floppy, they must be deliberately adjoined and maintained. When a load is particularly awkward or heavy, the handles may unintentionally separate, causing a user to lose his or her grasp of the load and/or balance.

Interlocking handles capable of adjoining with one another to create a unitary grip and thus avoid some of the problems of the prior art are known. Such handles, however, do not entirely eliminate the problems of the prior art as they fail to ensure that the handles remain in a locked position until intentionally and deliberately released. Moreover, many such interlocking handles comprise complex interlocking relationships that make it difficult and/or awkward to achieve an initial locked relationship.

Accordingly, what is needed is a locking handle device capable of achieving a locked unitary grip quickly and easily. Also what is needed is a locking handle device that is inexpensive to manufacture and simple to implement. Finally what is needed is a locking handle device that effectively and reliably maintains a locked position until intentionally and deliberately released.

Such devices and methods are disclosed and claimed herein.

### SUMMARY

The present invention is a locking handle device capable of securely engaging complementary handle components and preventing their disengagement except upon deliberate actuation of a releasing element.

In accordance with the invention as embodied and broadly described herein, the present invention features a first handle element and a second handle element having complementary configurations. The first handle element includes a receiving portion and a first base portion; the second handle element includes an engaging portion and a second base portion. The first and second base portions are coupled to the carrying case and reside opposite each other such that the receiving and engaging elements are substantially aligned. The first and second handles may then be brought into close proximity with each other such that the receiving element may receive the engaging element. In this manner, first and second handles lock to form a unitary handle grip.

The device further includes a release element integral with or attached to the first and second base portions. In certain embodiments, the release element comprises release areas situated on the outer corners of the first and second base portions. In other embodiments, the release element is located along other sections of the first or second base portions, or on any portion of the device that a user can actuate. A user may actuate the release element by, for example, pressing inwardly against two opposing release areas. The inward force used to press the release areas together transfers a substantially vertical force to effectively disengage the engaging portion from the receiving portion. As the complementary configurations of the engaging portion and receiving portion prevent inadvertent disengagement, and in fact prevent deliberate disengagement by any force other than an inward force applied to opposing release areas, the present invention effectively overcomes many of the problems of the prior art set forth above.

These and other features and advantages of the present invention will be set forth or will become more fully apparent in the description that follows. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### 4. BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1A is an exploded view of a locking handle device.

FIG. 1B is an isolated perspective view of the locking handle device in accordance with certain embodiments of the present invention;

FIG. 2A is a perspective view of a first handle portion of the locking handle device of FIG. 1B;

FIG. 2B is a profile view of a first handle portion of the locking handle device of FIG. 1B;

FIG. 3 is a perspective view of a second handle portion of the locking handle device of FIG. 1B;

FIG. 4 is an isolated bottom view of the interlocking grip portion of the second handle portion of FIG. 1B;

FIG. 5A is a profile view of the locking handle device in accordance with certain embodiments of the present invention in FIG. 1B indicating the force vector required to separate the first handle portion from the second handle portion;

FIG. 5B is a perspective view of the locking handle device of FIG. 1B implemented in connection with a carrying case; and

FIG. 6 is a block diagram detailing steps for selectively locking and unlocking handles of a carrying case in accordance with certain embodiments of the present invention.

### 5. DETAILED DESCRIPTION OF THE INVENTION

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The presently preferred embodiments of the invention will be best understood by reference to the drawings wherein like parts are designated by like numerals throughout.

As used in this specification, the term “carrying case” refers to a container or receptacle that may be used for holding, storing or carrying a load. A carrying case may include, for example, any bag, container, box, sack, pack, strip of fabric or similar structure or device that carries or contains a load.

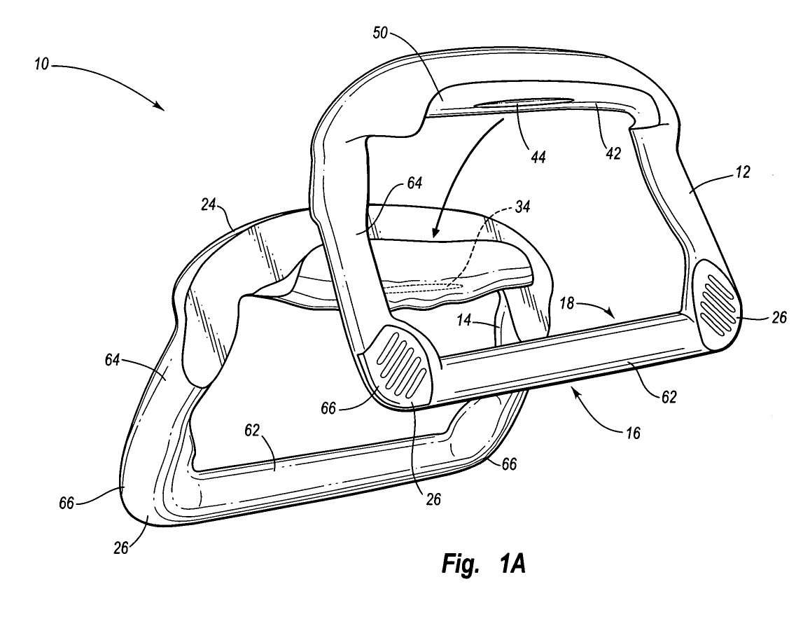

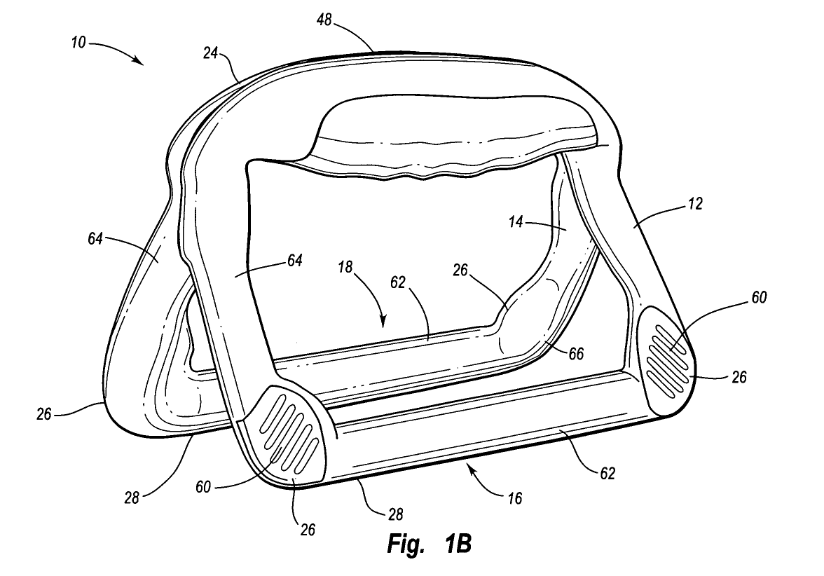

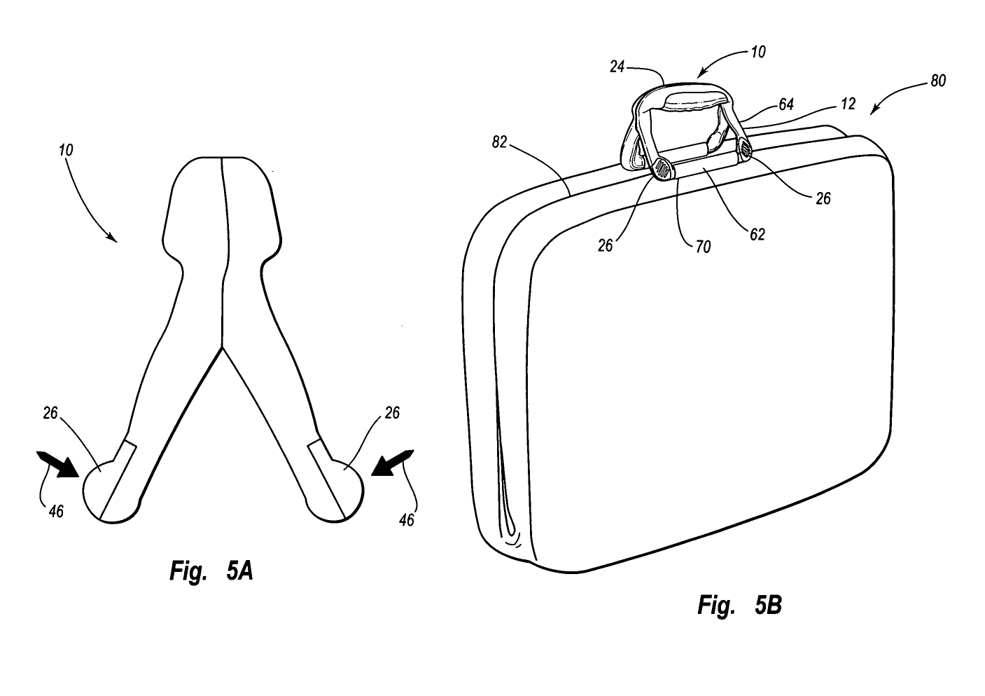

The present invention features a locking handle device 10 capable of securely engaging complementary handle components and preventing their disengagement except upon deliberate actuation of a release element 26. The locking handle device 10 in accordance with the present invention may assume a unitary closed structure, as depicted by FIGS. 1B, 5A and 5B, or an open structure, as depicted by FIGS. 1A, 2A, 2B and 3, depending on the engagement of the handle components.

The locking handle device 10 in accordance with the present invention may comprise any substantially rigid organic or synthetic material known to those in the art, including metal, plastic, wood, composite, or any combination thereof. In a closed position, the locking handle device 10 in accordance with the present invention may comprise a unitary grip portion 24 and a supportive base portion 28, as illustrated in FIG. 1B. The supportive base portion 28, as discussed in more detail below, may create a substantially pyramidal structure beneath the unitary grip portion 24 such that the locked device 10 may remain independently erect.

The unitary grip portion 24 may comprise the outer surface 50 and a handle interface 48. In certain embodiments, the outer surface 50 may comprise a material overlay to provide increased comfort and support to a user, such as rubber, plastic, fabric, or any other flexible or pliable overlay material known to those in the art. Alternatively, the unitary grip portion 24 may comprise a material similar or identical to the locking handle device 10 generally, and may be integral with the supportive base portion 28. In certain embodiments, the outer surface 50 of the unitary grip portion 24 may comprise finger depressions on an underside thereof to accommodate the fingers of a user during load transport. In other embodiments, the unitary grip portion 24 may comprise advertising and/or trademark material inscribed, engraved or otherwise integrated with the outer surface 50 thereof.

The handle interface 48 results from the abutment of complementary handle components in a closed position. Preferably, the abutting surfaces of opposing handle components are closely complementary to create an almost imperceptible interface 48. In certain embodiments, the handle interface 48 comprises two seams longitudinally disposed along an upper side of the unitary grip portion 24. Specifically, the handle interface 48 may extend substantially in parallel along a top surface and upper lateral surface of the unitary grip portion, respectively. In this manner, the position of the handle interface 48 avoids interference with a user's grip during load transport.

The supportive base portion 28 may comprise first base portion 16 and a second base portion 18 obliquely oriented to each other and held in position by virtue of the unitary grip portion 24 described above. Each of first and second base portion 16 and 18 may comprise at least one attachment portion 62 substantially parallel to and removed from the unitary grip portion 24, and at least one adjoining portion 64 extending substantially perpendicularly between the attachment portion 62 and the unitary grip portion 24. However, in other embodiments, first and second base portion 16 and 18 may be on an angle in relation to the unitary grip portion 24. In yet other embodiments, first and second base portion 16 and 18 may comprise a curved loop. These latter two embodiments may be appropriate when said carrying case is a monopack style bag where the bag shape is diagonal.

The release element 26 may be integrated with or attached to the supportive base portion 28. In certain embodiments, the release element 26 may comprise pressure spots 60 substantially corresponding to a corner juncture between the attachment portion 62 and adjoining portion 64 of each of the first and second base portions 16 and 18. Pressure spots 60 may comprise a material distinct from the material of the supportive base portion 28 to indicate the position of the pressure spots 60 and to provide increased comfort and support to a user. Pressure spots 60 may comprise, for example, textured fabric, rubber, plastic, or any other material known to those in the art capable of being overlaid, coupled to, or integrated with the supportive base portion 28 of the present invention and capable of providing increased comfort and support to a user.

Where the locking handle device 10 is in a closed position, a user may selectively apply opposing force to the pressure spots 60 to actuate release of the handle components. Specifically, inward application of pressure to pressure spots 60 located on first and second base portion 16 and 18, respectively, may transfer a substantially transverse and vertical force to the unitary grip portion 24 sufficient to displace a first handle portion 12 from a second handle portion 14 at the handle interface 48.

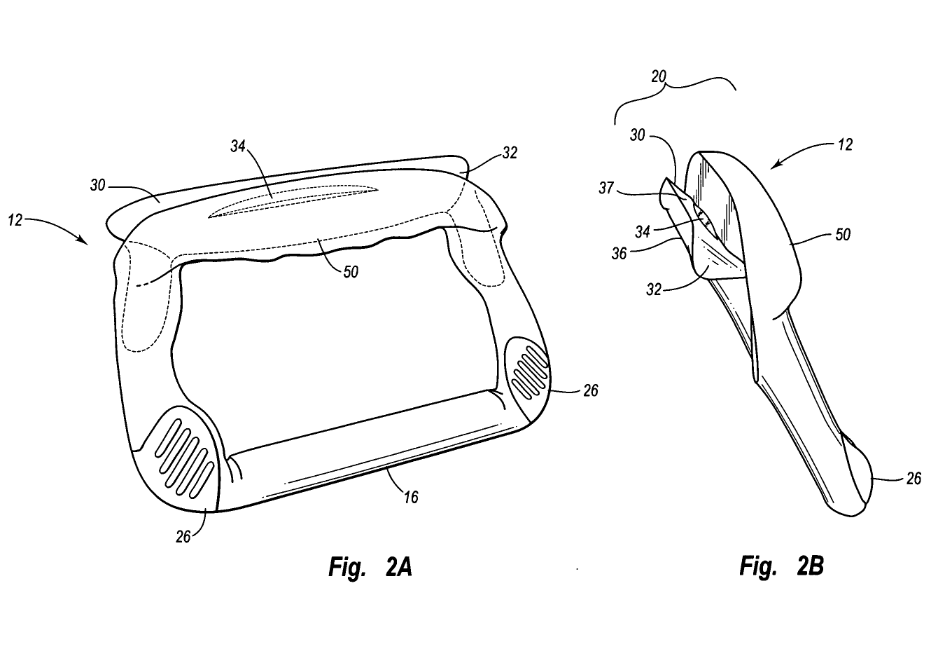

Indeed, handle components of locking handle device 10 in accordance with the present invention may comprise the first handle portion 12 and the second handle portion 14 having complementary configurations, such that, when engaged, the first handle portion 12 and second handle portion 14 create the unitary grip portion 24 described above and depicted by FIG. 1B. Referring now to FIG. 2A, the first handle portion 12 in accordance with the present invention may comprise a portion of the outer surface 50 of the unitary grip portion 24 of FIG. 1B, an inner surface 30, and first base portion 16. The inner surface 30 may comprise a cradle portion 32 and a lip 34. The cradle portion 32 may comprise a substantially asymmetrical configuration, having one side 36 that is substantially flat and parallel to the corresponding outer surface 50, and having an opposite side 37 that is set at an outward incline. The inclined side 37 may comprise the projecting lip 34 attached to or integrated into a surface thereof. The cradle portion 32 and lip 34 may combine to selectively secure the second handle portion 14 having a complementary configuration into a locked position, as depicted by FIG. 1B. The inner surface 30, cradle portion 32, lip 34, one side 36 and opposite side 37 are collectively referred to as a receiving element (or portion) 20 of the first handle portion 12. The receiving element 20 contributes to coupling the first handle portion 12 to the second handle portion 14 and also includes all portions of the first handle portion 12 that contribute to coupling the first handle portion 12 to the second handle portion 14.

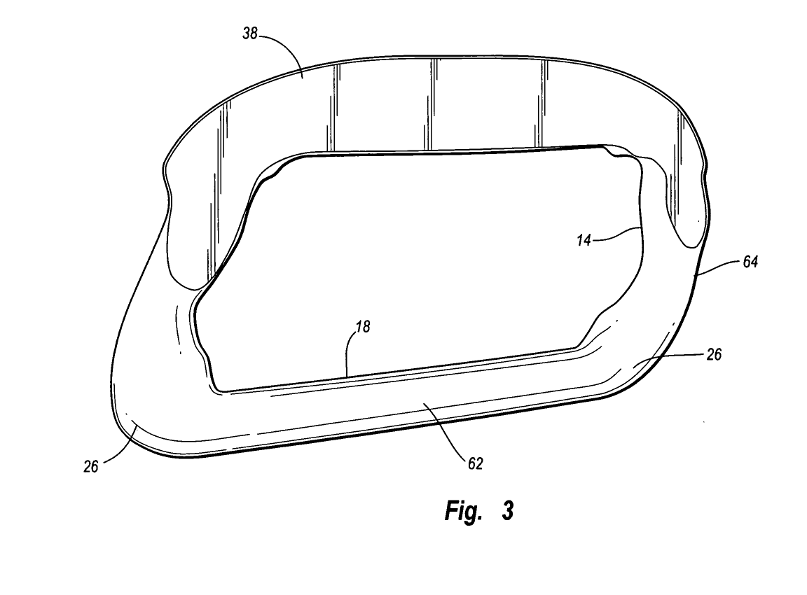

Referring now to FIG. 3, the second handle portion 14 may comprise a plate member 38 and second base portion 18. The plate member 38 may substantially correspond to and be engageable with the cradle portion 32 of the first handle portion 12 so as to facilitate a closed and locked position of the locking handle device 10. The plate member 38 may be transversely oriented relative to the second base portion 18 such that the plate member 38 may slidably engage the cradle portion 32 of the first handle portion 12 substantially adjacent its inclined side 37.

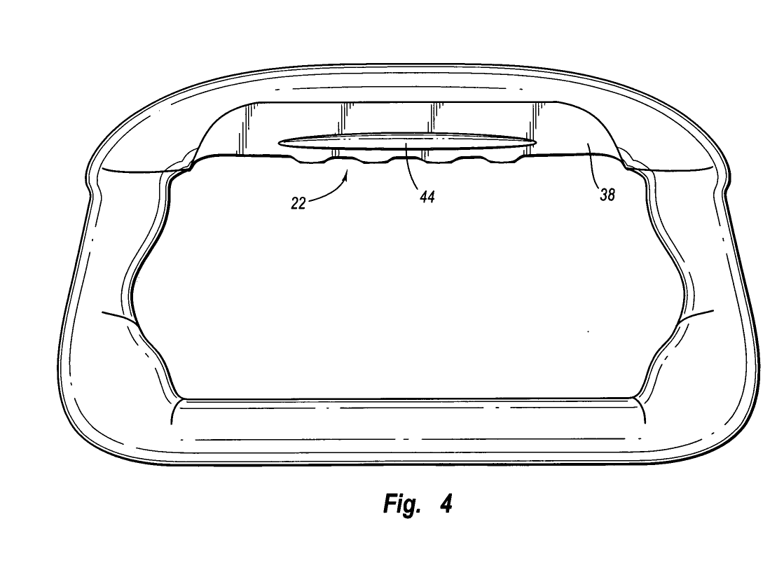

Referring now to FIG. 4, the plate member 38 may further comprise a groove 44 on an underside thereof that is complementary to the lip 34 of the cradle portion 32, such that the first and second handle portions 12 and 14 may be selectively locked thereby. The plate member 38 and groove 44 are collectively referred to as an engaging element 22 of the second handle portion 14. In some embodiments, engaging element 22 also includes all portions of the second handle portion 14 that contribute to coupling the second handle portion 14 to the first handle portion 12. The groove 44 and lip 34 may be configured to allow disengagement only upon application of a substantially upward and transverse force. The locking handle device 10 thus prevents inadvertent disengagement of the first and second handle portions 12 and 14 by requiring deliberate application of a unique combination of forces, which may only be implemented by virtue of the release element 26 of the present invention. In this manner, the locking handle device 10 of the present invention also prevents intentional disengagement of the complementary handle components by a young child or other person who is unfamiliar with the novel release system of the present invention.

Referring now to FIG. 5A, which shows the handle in a closed position with both handle portions selectively coupled in a nested position. Furthermore, FIG. 5A illustrates force vectors 46 required to decouple the handle portions by placing force on release element 26.

Referring now to FIG. 5B, the locking handle device 10 of the present invention is capable of implementation in connection with a carrying case 80 or other such device known to those in the art. In certain embodiments, the locking handle device 10 is attached to carrying case 80 by an attachment means 70, substantially adjacent a primary opening 82 thereof. Attachment means 70 may comprise stitching, rivets, screws, adhesives, or any other attachment means known to those in the art. The primary opening 82 may comprise a zipper closure, a snap closure, a button closure, a hook and loop closure, or any other closure known to those in the art. In certain embodiments, the primary opening 82 is devoid of closure means. In other embodiments, carrying case 80 comprises a strip of fabric for carrying a load.

In one embodiment, for example, carrying case 80 may comprise a briefcase with a zipper closure as the primary opening 82. The first handle portion 12 of the present invention may be coupled to the briefcase laterally adjacent the zipper. The second handle portion 14 may also be coupled to the briefcase laterally adjacent the zipper, substantially opposite the first handle portion 12. In this manner, the complementary features of the first and second handle portions 12 and 14 substantially align to facilitate their selective engagement. The flexible nature of the carrying case 80 enables the second handle portion 14 to approach the first handle portion 12 from a substantially elevated position, thereby enabling the engaging element 22 of the second handle portion 14 to slidably engage the receiving element 20 of the first handle portion 12. The two handle portions 12 and 14 may be selectively disengaged as described above to facilitate access to briefcase contents.

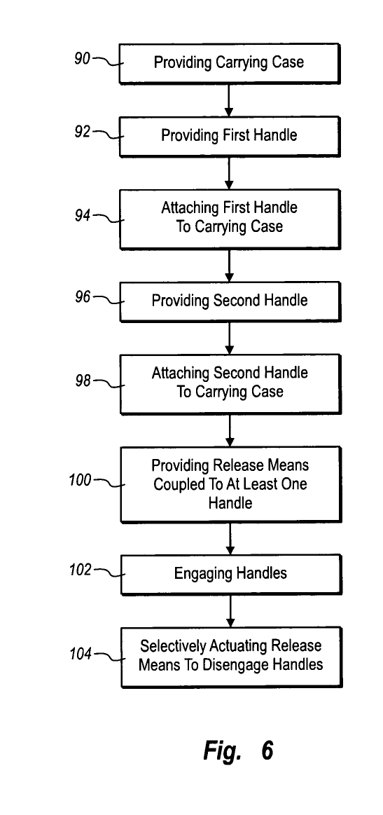

Referring now to FIG. 6, a method for selectively locking and unlocking handles of a carrying case in accordance with the present invention may comprise first providing a carrying case having a primary opening 90. A next step may comprise providing a first handle portion having a receiving portion 92. The first handle portion may be attached to the carrying case substantially adjacent the primary opening by any attachment means known to those in the art 94. Next, the method may comprise providing a second handle portion having an engaging portion 96. The second handle portion may be coupled to the carrying case in a manner similar or identical to the attachment of the first handle portion 98. Release means may be coupled to at least one of the first and second handles to enable selective release of the first and second handle portions 100. A next step of the method may comprise engaging the first and second handle portions such that the engaging portion of the second engages the receiving portion of the first 102. A final step of the method may comprise selectively actuating the release elements of the first and second portions to transfer a substantially vertically oblique force to the engaging portion to effectuate the disengagement of the handle portions 104.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A locking handle device for a carrying case having a primary opening, said locking handle device comprising:
a first handle having a receiving portion and a first base portion, wherein said first base portion is coupled to said carrying case substantially adjacent to said primary opening;
a second handle having an engaging portion and a second base portion, wherein said engaging portion is capable of selectively slidably engaging and locking said receiving portion of said first handle, said second base portion coupled to said carrying case substantially opposite said first base portion; and
a release element coupled to at least one of said first base portion and said second base portion, wherein said release element may be selectively actuated to disengage said first handle from said second handle.

2. The locking handle device of claim 1, wherein said receiving portion further comprises a cradle portion having at least one substantially inclined surface.

3. The locking handle device of claim 2, said cradle portion further comprising at least one projecting lip.

4. The locking handle device of claim 2, wherein said engaging portion further comprises a plate member having a configuration complimentary to said cradle portion.

5. The locking handle device of claim 4, wherein said plate member is oriented substantially transversely relative to said second base portion.

6. The locking handle device of claim 3, said engaging portion comprising a top surface and a bottom surface, said bottom surface comprising a groove capable of receiving and locking said projecting lip of said cradle portion.

7. The locking handle device of claim 1, wherein said release element comprises opposing pressure points corresponding to at least one corner of each of said first and said second base portions.

8. The locking handle device of claim 1, wherein said release element comprises opposing pressure points corresponding to said first and said second base portions.

9. The locking handle device of claim 7, wherein said release element may be selectively actuated by applying inward force to opposing pressure points.

10. The locking handle device of claim 1, wherein said release element transfers a substantially vertical and transverse force to said second handle portion upon actuation.

11. A locking handle assembly for a carrying case having a primary opening, comprising:
a grip portion having an engaging element and a receiving element, said engaging element capable of selectively engaging and locking said receiving element;
a base portion coupled to said grip portion and to said carrying case substantially adjacent said primary opening; and
release means for selectively releasing said engaging element from said receiving element, said release means coupled to said base portion.

12. The locking handle assembly of claim 11, said receiving element comprising a cradle portion having at least one substantially inclined surface.

13. The locking handle assembly of claim 11, said receiving element further comprising at least one projecting lip.

14. The locking handle assembly of claim 11, said engaging element comprising a plate member having a substantially oblique relationship to said base portion.

15. The locking handle assembly of claim 14, said engaging element further comprising at least one groove.

16. The locking handle assembly of claim 15, wherein said at least one groove is capable of retaining said at least one projecting lip.

17. The locking handle assembly of claim 11, wherein base portion comprises at least one pair of opposing corners.

18. The locking handle assembly of claim 17, wherein said release means comprises opposing pressure points corresponding to said at least one pair of opposing corners.

19. The locking handle assembly of claim 11, wherein said release means comprises opposing pressure points corresponding to said base portion.

20. The locking handle assembly of claim 18, wherein said release means may be selectively actuated by applying inward force to said opposing pressure points.

21. The locking handle assembly of claim 20, wherein said release means transfers a substantially vertical and transverse force to said engaging element upon actuation.

22. A method for selectively locking and unlocking handles of a carrying case, comprising:
providing a carrying case having a primary opening;
providing a first handle having a receiving portion and a first release element;
coupling said first handle to said carrying case substantially adjacent said primary opening;
providing a second handle having an engaging portion and a second release element,
coupling said second handle to said carrying case substantially opposite said first handle and substantially adjacent said primary opening;
engaging said engaging portion with said receiving portion to lock said handles of said carrying case; and
selectively actuating said first and second release elements to transfer a substantially vertical and transverse force to said second handle to unlock said handles of said carrying case.

23. A locking handle device for a carrying case having a primary opening, said locking handle device comprising:
a first handle having a receiving portion and a first base portion, wherein said first base portion is coupled to said carrying case substantially adjacent to said primary opening and wherein said receiving portion further comprises a cradle portion having at least one substantially inclined surface and at least one projecting lip;
a second handle having an engaging portion and a second base portion, wherein said engaging portion comprises a top surface and a bottom surface, said bottom surface comprising a groove capable of receiving and locking said projecting lip of said cradle portion and wherein said engaging portion is capable of selectively slidably engaging and locking said receiving portion of said first handle, said second base portion coupled to said carrying case substantially opposite said first base portion and further comprising a plate member having a configuration complimentary to said cradle portion, wherein said plate member is oriented substantially transversely relative to said second base portion; and
a release element comprising opposing pressure points corresponding to at least one corner of each of said first and said second base portions, wherein said release element is coupled to at least one of said first base portion and said second base portion, wherein said release element may be selectively actuated to disengage said first handle from said second handle by applying inward force to opposing pressure points and wherein said release element transfers a substantially vertical and transverse force to said second handle portion upon actuation.
